(19) United States
(12) Patent Application Publication
(10) Pub. No.: US 2022/0312808 A1
(43) Pub. Date: Oct. 6, 2022

(54) Canned Hummus Mix and Methods for Preparing and Using the Same

(71) Applicant: Laura Grosso, West Olive, MI (US)

(72) Inventor: Laura Grosso, West Olive, MI (US)

(21) Appl. No.: 17/708,036

(22) Filed: Mar. 30, 2022

Related U.S. Application Data
(60) Provisional application No. 63/167,814, filed on Mar. 30, 2021.

(51) Int. Cl. A23L 11/00; A23L 25/00

(52) U.S. Cl. CPC A23L 11/05; A23L 25/30

(57) ABSTRACT

A method for preparing a hummus mix, including the steps of: (a) filling a container with fresh hummus ingredients from a predetermined recipe; (b) sealing the container; and (c) processing the filled container using a thermal processor to, in turn, generate a hummus mix with an extended shelf-life.

### CROSS-REFERENCE TO RELATED APPLICATIONS

This application claims the benefit of U.S. Provisional Application Ser. No. 63/167,814, entitled “CANNED HUMMUS MIX AND METHODS FOR PREPARING AND USING THE SAME,” filed Mar. 30, 2021—which is hereby incorporated herein by reference in its entirety, including all references cited therein.

### STATEMENT REGARDING FEDERALLY SPONSORED RESEARCH OR DEVELOPMENT

Not applicable.

### REFERENCE TO A SEQUENCE LISTING

Not applicable.

### BACKGROUND OF THE INVENTION

### 1. Field of the Invention

The present invention relates in general to hummus mixes, and, more particularly, to extended shelf-life (ESL) canned hummus mixes that are easily convertible into hummus dips and/or spreads with nominal processing. The extended shelf-life canned hummus products of the present invention are preferably low-acid and provide both superior flavor and consistency.

The present invention further relates to methods for preparing and using canned hummus mixes.

### 2. Background Art

Extended shelf-life food products and methods for preparing the same have been known in the art for years and are the subject of a plurality of patents and publications, including: U.S. Pat. No. 6,602,531 entitled “Method for Pre-Processing of Dried Food,” U.S. Pat. No. 6,482,457 entitled “Method for Producing a Reconstitutable Dehydrated Food Product,” U.S. Pat. No. 6,387,437 entitled “High Pressure Process and System for the Production of Fresh Whole Corn Masa, Nixtamalized Whole Corn Flour, and Derived Products,” U.S. Pat. No. 6,152,024 entitled “Apparatus and Method for Producing a Food Product,” U.S. Pat. No. 5,124,170 entitled “Concentrated Frozen Leguminous Products,” United States Patent Application Publication Number 2018/0027854 entitled “Shelf Stable Hummus Food Product and Mix Kit,” United States Patent Application Publication Number 2005/0238787 entitled “Process for Manufacturing Dehydrated Precooked Flaked Pinto Beans,” United States Patent Application Publication Number 2003/0068417 entitled “Method for Producing a Dehydrated Whole Food Product,” International Patent Application Publication Number WO 2007/088540 entitled “Concentrate Paste for Dips/Spreads and Process for Their Preparation,” and Canadian Patent Number CA 2,202,778 entitled “Dehydrated Pea Soup and Method of Making the Same”—all of which are hereby incorporated herein by reference in their entirety including all references cited therein.

U.S. Pat. No. 6,602,531 appears to disclose a pre-drying manufacturing process and related equipment for application to food products that are to be dried that calls for a non-re-hydration or soaking treatment of the food prior to drying using a unique activated smoke liquid solution diluted with deep sea water. The treatment greatly improves the processing, cooking and/or physical characteristics of the dried food when it is later reconstituted and used. The unique activated smoke liquid solution is made from a special process which gives it the desired characteristics which, when properly applied before drying, result in improved quality of dried food when later reconstituted. The pre-drying food treatment apparatus optionally include spray or immersion equipment. The spray equipment may utilize inert gases that further contribute to improved characteristics in the treated food. By applying the unique smoke liquid solution according to the present invention, no soaking or immersion of the dried food products in water or liquid is necessary prior to processing or cooking. The resulting dried food immediately absorbs water for prompt processing or cooking; it has increased weight and volume; it has a prolonged shelf life; and it retains much of its original food texture after being freeze-thawed.

U.S. Pat. No. 6,482,457 appears to disclose a method for producing a reconstitutable dehydrated food product and an apparatus for producing such a product. The method calls for the use of a stationary vessel that is used as both a hydration device and a pressure cooker. A rotating member within the vessel ensures that the vessel contents are continuously mixed, and that fluids within the vessel are continuously spread through the contents. The apparatus also has a channel, wherein the food product is chopped and sized as desired, before going through a forming conduit that spreads the product into a generally flat sheet of texturized composition. The method and apparatus produce a dehydrated food product of a desired texture, with improved water absorption qualities and enhanced digestibility.

U.S. Pat. No. 6,387,437 appears to disclose a high-pressure process and system for the production of fresh whole corn masa, nixtamalized whole corn flour, and derivates wherein dry corn grains are transported by means of an elevator to a series of cleaning screens to separate impurities and foreign material before they are subjected to a cooking step. The corn grains as well as lime and water are fed continuously to a cooking device, which is subjected under a combination of pressure and temperature, to reduce the time of cooking of the whole corn grains. So, nixtamalized corn grains are obtained for the preparation of fresh whole corn masa and nixtamalized whole corn flour for tortillas, tortilla chips or the like.

U.S. Pat. No. 6,152,024 appears to disclose an apparatus and method of producing a food product. The food product is placed inside of an air-tight chamber, in which the food product is to be cooked, wherein steam is generated from a source of water and is introduced into the cooking chamber. The steam heats the inside of the cooking chamber and serves as a heat transfer media to heat the food product, as well as a color and flavor transfer media to color and flavor the food product. That is, a flavoring and coloring additive, such as liquid smoke, may be added to the water utilized in generating the steam in order to flavor the food product being cooked. The steam then transfers the flavoring and coloring additive to the food product which condenses on the food product adding flavor and color to the food product.

U.S. Pat. No. 5,124,170 appears to disclose a frozen leguminous food product and method for preparing the same. The process comprises the steps of cleaning the legumes, removing all unwanted material, tempering the legumes until they are partially but evenly hydrated, steam cooking the legumes in direct injected live steam, crushing the legumes between rolls, forming the legumes into nuggets, and quick freezing the resultant nuggets. The nuggets are generally cube shaped and measure approximately ⅜ inch on a side. They contain 50-65 percent solid food product. The disclosed process eliminates the possibility of scorching during slow cooking as is common in the industry. The disclosed process also results in a finished product which, when reconstituted, has the color and aroma of a food product prepared from fresh legumes.

United States Patent Application Publication Number 2018/0027854 appears to disclose a shelf stable hummus food product having three ingredients; chickpeas, tahini, and spices. To keep the hummus mixture shelf stable for a longer period, it is best to isolate the chickpeas from tahini and spices until it is ready for consumption. The three ingredients are provided in their own separate packages or bags. When required to make one, the consumer has to: rip open each packet; empty the contents completely into a container; and stir all ingredients together thoroughly until smooth. During this stirring or mixing process, the tahini mixes with the water from the chickpea puree and before the bacteria activity begins and disintegration starts, the citric acid: a) helps combining the ingredients forming a homogenous creamy and smooth paste; b) acts as an emulsifying agent to keep the tahini, water and chickpea from separating.

United States Patent Application Publication Number 2005/0238787 appears to disclose a process for manufacturing dehydrated precooked flaked pinto beans begins with cleaning a quantity of beans. The cleaned beans are then pressure cooked. Following cooking, the beans are deposited on a perforated conveyor for transportation through a first dehydrator which reduces the moisture content of the beans to about 20%. The cooked dehydrated pinto beans are then directed through a roller mill to convert the beans into flakes. Alternative to being dehydrated in a first dehydrator before being converted into flakes, the beans may be separated on a water separating conveyor and not undergo any dehydration. The cooked dehydrated bean flakes are then transported through a dehydrator which reduces the moisture content thereof to less than about 10%.

United States Patent Application Publication Number 2003/0068417 appears to disclose a method of preparing a reconstitutable, dehydrated whole bean product. The method calls for utilizing a combination convection/microwave heating chamber to dry cooked whole beans in such a way as to preserve the integrity of the beans and, thus, significantly enhance the texture and quality of the bean product. The method requires a shorter amount of time than, and enables a significant reduction in the amount of bird mouthing that, is prevalent in existing methods.

International Patent Application Publication Number WO 2007/088540 appears to disclose an edible paste concentrate consisting of ground chickpeas, cooked and dried, and crushed sesame seeds. The paste has a shelf life of at least three months, and when mixed with water, provides a dip or a spread with the flavor and texture of freshly prepared hummus. Also provided is a process for manufacturing a spread or a dip from chickpeas or other legumes.

Canadian Patent Number CA 2,202,778 appears to disclose a method for forming a dehydrated leguminous food product for reconstitution into a ready-to-eat food product. The method comprises the steps of cleaning the food product, removing all unwanted material, tempering the food product until it is partially hydrated, steam cooking the food product in a low-pressure steam environment, smoothly crushing the food product between at least one pair of rolls, dehydrating the food product, and breaking up the food product to a desired size. The food product produced by the present method has a moisture content of approximately 4% to 14%, and preferably 10%. The product formed by the present method is instantly reconstitutable and has the color, appearance, texture, aroma, and consistency of conventionally prepared pea soup.

While the above-identified patents and publications do appear to disclose various extended shelf-life food products and methods for preparing the same, their processing techniques remain non-desirous and/or problematic inasmuch as, among other things, none of the above-identified patents and publications appear to provide preservative-free, extended shelf-life canned hummus mixes that are easily convertible into hummus dips and/or spreads with nominal processing, and which provide both superior flavor and consistency.

These and other objects of the present invention will become apparent in light of the present specification, claims, and drawings.

### SUMMARY OF THE INVENTION

The following presents a simplified summary in order to provide a basic understanding of some aspects of the claimed subject matter. This summary is not an extensive overview, and is not intended to identify key/critical elements or to delineate the scope of the claimed subject matter. Its purpose is to present some concepts in a simplified form as a prelude to the more detailed description that is presented later.

The present invention is directed to a method for preparing a hummus mix, comprising, consisting essentially of, and/or consisting of the steps of: (a) filling a container with fresh hummus ingredients from a predetermined recipe; (b) sealing the container; and (c) processing the filled container using a thermal processor to, in turn, generate a hummus mix having an extended shelf-life.

In a preferred embodiment of the present invention, the hummus mix is low-acid and preservative free.

In another preferred embodiment of the present invention, the shelf-life of the hummus mix is greater than one year.

In yet another preferred embodiment of the present invention, the shelf-life of the hummus mix is greater than two years.

In a preferred implementation of the present invention, the predetermined recipe is: chickpeas (6.6 ounces); tahini (3 ounces); lemon juice (1.2 ounces); garlic (0.15 ounces); Himalayan salt (0.1 ounces); cumin (0.5 ounces); and at least one of water and oil (1.2 ounces).

In another preferred implementation of the present invention, the predetermined recipe is: chickpeas (6.6 ounces); roasted red pepper (3.55 ounces); tahini (2 ounces); lemon juice (1.2 ounces); garlic (0.15 ounces); salt (0.1 ounces); red pepper flakes (0.25 ounces); and at least one of water and oil (1.2 ounces).

In yet another preferred implementation of the present invention, the thermal processing parameters are ambient pressure and time sufficient for the internal temperature to reach 153 degrees Fahrenheit.

In another aspect of the present invention, the thermal processing parameters are ambient pressure and flash freezing the contents to 32 degrees Fahrenheit in five minutes or less.

The present invention is further directed to a method for using a hummus mix, comprising, consisting essentially of, and/or consisting of the steps of: (a) providing a hummus mix having an extended shelf-life as disclosed supra; (b) emptying the hummus mix into a blender; (c) optionally adding additional oil and/or water to the blender; (d) optionally adding additional ingredients; (e) blending the contents in the blender for a period of time to homogenize the same; and (f) serving the homogenized hummus.

The present invention is also directed to hummus prepared according to the processes disclosed supra.

The present invention is yet further directed to a method for preparing and using a hummus mix, comprising, consisting essentially of, and/or consisting of the steps of: (a) filling a container with fresh hummus ingredients from a predetermined recipe; (b) sealing the container; (c) processing the filled jar/pouch using a thermal processor to, in turn, generate a hummus mix having an extended shelf-life; (d) storing the processed hummus mix for a period of time; (e) emptying the stored hummus mix into a blender; (f) optionally adding additional oil and/or water to the blender; (g) optionally adding additional ingredients; (h) blending the contents in the blender for a period of time to homogenize the hummus; and (i) serving the homogenized hummus having the same flavor and consistency of freshly prepared hummus.

### BRIEF DESCRIPTION OF THE DRAWINGS

Certain embodiments of the present invention are illustrated by the accompanying figures. It will be understood that the figures are not necessarily to scale and that details not necessary for an understanding of the invention or that render other details difficult to perceive may be omitted.

It will be further understood that the invention is not necessarily limited to the particular embodiments illustrated herein.

The invention will now be described with reference to the drawings wherein:

FIG. 1 of the drawings is a flow chart of a process for preparing hummus mix in accordance with the present invention; and

FIG. 2 of the drawings is a flow chart of a process for using hummus mix in accordance with the present invention.

### DETAILED DESCRIPTION OF THE INVENTION

While this invention is susceptible of embodiment in many different forms, there is shown in the drawings and described herein in detail several specific embodiments with the understanding that the present disclosure is to be considered as an exemplification of the principles of the invention and is not intended to limit the invention to the embodiments illustrated.

It will be understood that like or analogous elements and/or components, referred to herein, may be identified throughout the drawings by like reference characters. In addition, it will be understood that the drawings are merely schematic representations of one or more embodiments of the invention, and some of the components may have been distorted from their actual scale for purposes of pictorial clarity.

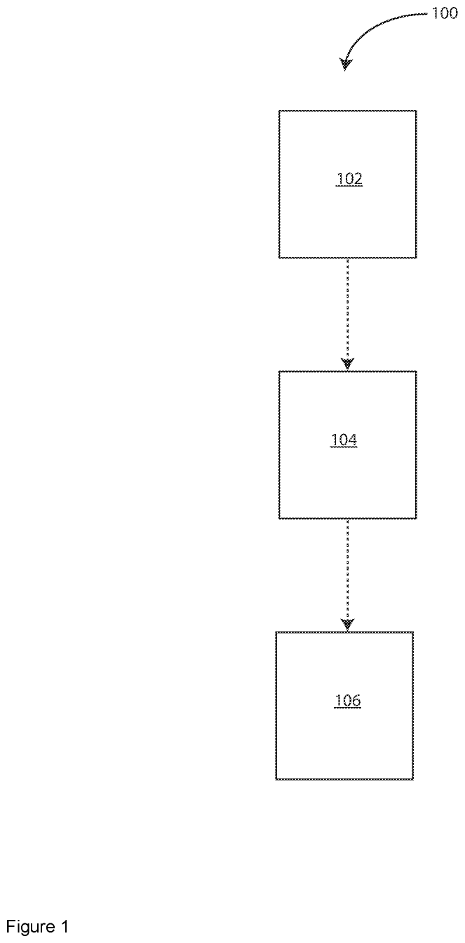

As is best shown in FIG. 1, the present invention is directed to method 100 for preparing a hummus mix, comprising the steps of: filling 102 a container with fresh hummus ingredients from a predetermined recipe, such as, but not limited to, those disclosed herein; sealing 104 the container; and processing 106 the filled container using a thermal processor to, in turn, generate a hummus mix having an extended shelf-life. Preferably, the hummus mix is low-acid and/or preservative free, and the shelf-life is greater than one year, and more preferably greater than two years.

Non-limiting examples of recipes are provided below:

### Example I

| Ingredient | Amount | Variation |
|---|---|---|
| Chickpeas | 6.6 ounces | +/−5% |
| Tahini | 3 ounces | +/−5% |
| Lemon Juice | 1.2 ounces | +/−5% |
| Garlic | 0.15 ounces | +/−5% |
| Himalayan Salt | 0.1 ounces | +/−10% |
| Cumin | 0.5 ounces | +/−20% |
| Oil/Water | 1.2 ounces | +/−25% |

### Example II

| Ingredient | Amount | Variation |
|---|---|---|
| Chickpeas | 6.6 ounces | +/−5% |
| Roasted Red Pepper | 3.55 ounces | +/−5% |
| Tahini | 2 ounces | +/−5% |
| Lemon Juice | 1.2 ounces | +/−5% |
| Garlic | 0.15 ounces | +/−5% |
| Salt | 0.1 ounces | +/−10% |
| Red Pepper Flakes | 0.25 ounces | +/−20% |
| Oil/Water | 1.2 ounces | +/−25% |

In a preferred embodiment of the present invention, the thermal processing parameters are ambient pressure coupled with time sufficient for the internal temperature of the ingredients to reach approximately (+/−5%) 153 degrees Fahrenheit. Alternatively, and/or additionally the thermal processing parameters may include cooling the contents to below approximately (+/−5%) 39 degrees Fahrenheit in 15 minutes or less, and/or flash freezing the contents to approximately (+/−5%) 32 degrees Fahrenheit in five minutes or less, and preferably in 30 seconds or less.

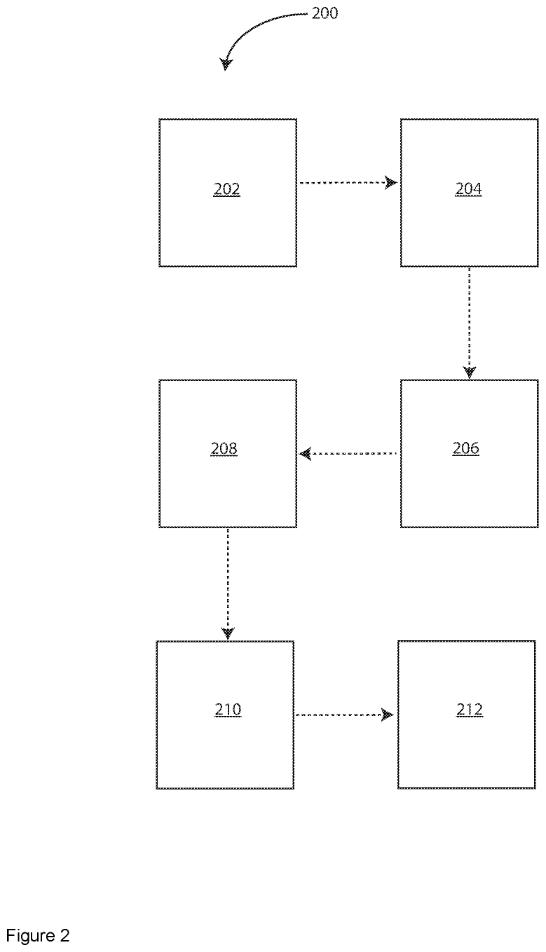

Referring now to FIG. 2, the present invention is also directed to method 200 for using a hummus mix, comprising the steps of: providing 202 a hummus mix having an extended shelf-life as disclosed herein above; emptying 204 the hummus mix into a blender; optionally adding 206 additional oil and/or water to the blender (oil and/or water may be added before storage and/or after storage during, for example, blending); optionally adding 208 additional ingredients (e.g., herbs, spices, proteins, fats, carbohydrates, flavorants, colorants, homeopathic medicaments, traditional medicaments, etcetera); blending 210 the contents in the blender for a period of time to homogenize, (e.g., low-sheer, high-sheer) constitute and/or reconstitute the same; and 212 serving the hummus.

It will be understood that while certain embodiments of the present invention are directed toward hummus, other products and dips are likewise contemplated for use, including, but not limited to, white bean dip, pinto bean dip, black bean dip, legume dips/products, pulse crop dips/products, etcetera.

The foregoing description merely explains and illustrates the invention and the invention is not limited thereto except insofar as the appended claims are so limited, as those skilled in the art who have the disclosure before them will be able to make modifications without departing from the scope of the invention.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etcetera shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etcetera. As a non-limiting example, each range discussed herein can be readily broken down into a lower third, middle third and upper third, etcetera. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

What is claimed and desired to be secured by Letters Patent of the United States is:

1. A method for preparing a hummus mix, comprising the steps of:
filling a container with fresh hummus ingredients from a predetermined recipe;
sealing the container; and
processing the filled container using a thermal processor to, in turn, generate a hummus mix having an extended shelf-life.

2. The method according to claim 1, wherein the hummus mix is low-acid and preservative free.

3. The method according to claim 1, wherein the shelf-life is greater than one year.

4. The method according to claim 1, wherein the shelf-life is greater than two years.

5. The method according to claim 1, wherein the predetermined recipe is:
Chickpeas (6.6 ounces);
Tahini (3 ounces);
Lemon Juice (1.2 ounces);
Garlic (0.15 ounces);
Himalayan Salt (0.1 ounces);
Cumin (0.5 ounces); and
at least one of water and oil (1.2 ounces).

6. The method according to claim 1, wherein the predetermined recipe is:
Chickpeas (6.6 ounces);
Roasted Red Pepper (3.55 ounces)
Tahini (2 ounces);
Lemon Juice (1.2 ounces);
Garlic (0.15 ounces);
Salt (0.1 ounces);
Red Pepper Flakes (0.25 ounces); and
at least one of water and oil (1.2 ounces).

7. The method according to claim 1, wherein the thermal processing parameters are ambient pressure and time sufficient for the internal temperature to reach 153 degrees Fahrenheit.

8. The method according to claim 1, wherein the thermal processing parameters are ambient pressure and flash freezing the contents to 32 degrees Fahrenheit in five minutes or less.

9. A method for using a hummus mix, comprising the steps of:
providing a hummus mix having an extended shelf-life in accordance with claim 1;
emptying the hummus mix into a blender;
optionally adding additional oil and/or water to the blender;
optionally adding additional ingredients;
blending the contents in the blender for a period of time to homogenize the same; and
serving the homogenized hummus.

10. Hummus prepared according to the process of claim 9.

11. A method for preparing and using a hummus mix, comprising the steps of:
filling a container with fresh hummus ingredients from a predetermined recipe;
sealing the container;
processing the filled container using a thermal processor to, in turn, generate a hummus mix having an extended shelf-life;
storing the processed hummus mix for a period of time;
emptying the stored hummus mix into a blender;
optionally adding additional oil and/or water to the blender;
optionally adding additional ingredients;
blending the contents in the blender for a period of time to homogenize the hummus; and
serving the homogenized hummus having the same flavor and consistency of freshly prepared hummus.

12. Hummus prepared according to the process of claim 11.
